(19) United States
(12) Patent Application Publication
(10) Pub. No.: US 2026/0312035 A1
(43) Pub. Date: Oct. 8, 2026

(54) CATHODE ACTIVE MATERIAL

(71) Applicant: TOYOTA JIDOSHA KABUSHIKI KAISHA, Toyota-shi (JP)

(72) Inventor: Ryosuke OHSAWA, Okazaki-shi (JP)

(73) Assignee: TOYOTA JIDOSHA KABUSHIKI KAISHA, Toyota-shi (JP)

(21) Appl. No.: 19/548,114

(22) Filed: Feb. 24, 2026

(30) Foreign Application Priority Data
Apr. 2, 2025 (JP) 2025-060878

(51) Int. Cl. H01M 4/525; C01G 53/506; H01M 4/36; H01M 10/052

(52) U.S. Cl. CPC H01M 4/525; C01G 53/506; H01M 4/366; H01M 10/052; C01P 2002/50; C01P 2002/85; C01P 2004/04; C01P 2004/80; C01P 2006/40

(57) ABSTRACT

A cathode active material includes: a surface layer that is a region extending from the surface toward the center of the cathode active material to a predetermined depth T; and a core layer that is a region extending from the predetermined depth T to the center. The surface layer contains at least Ni and does not contain Mn. The core layer has, in TEM-EDX analysis, a first peak derived from Mn in a range of 640 eV to 650 eV and contains Mn corresponding to the first peak. The predetermined depth T is 0.9 nm or more and 10 nm or less.

### CROSS-REFERENCE TO RELATED APPLICATION

This application claims priority to Japanese Patent Application No. 2025-060878 filed on Apr. 2, 2025. The disclosure of the above-identified application, including the specification, drawings, and claims, is incorporated by reference herein in its entirety.

### BACKGROUND

### 1. Technical Field

The present disclosure relates to cathode active materials.

### 2. Description of Related Art

Various techniques have been proposed regarding cathode active materials such as those disclosed in Japanese Unexamined Patent Application Publication Nos. 2021-114411 (JP 2021-114411 A) and 2012-33482 (JP 2012-33482 A).

### SUMMARY

Conventionally, various cathode active materials have been proposed in order to obtain cathodes having excellent battery characteristics such as high cycle characteristics and high output characteristics.

For cathode active materials containing nickel and manganese, there is still room for improvement in the internal resistance of a battery when these materials are used.

The present disclosure has been made in view of the above, and a primary object thereof is to provide a cathode active material that can reduce the internal resistance of a battery.

That is, the present disclosure includes the following aspects.

(1) A cathode active material including:
a surface layer that is a region extending from the surface toward the center of the cathode active material to a predetermined depth T; and a core layer that is a region extending from the predetermined depth T to the center, wherein:
the surface layer contains at least Ni and does not contain Mn;
the core layer has, in transmission electron microscopy-energy dispersive X-ray spectroscopy (TEM-EDX) analysis, a first peak derived from Mn in the range of 640 eV to 650 eV and contains Mn corresponding to the first peak; and the predetermined depth T is 0.9 nm or more and 10 nm or less.

(2) The cathode active material according to (1), wherein the core layer further contains Li, Ni, and Co.

(3) The cathode active material according to (1) or (2), wherein the predetermined depth T is 1.0 nm.

(4) A battery including a cathode layer containing the cathode active material according to any one of (1) to (3).

(5) A method for producing the cathode active material according to any one of (1) to (3), the method including:
performing first firing in which a first mixture of a transition metal hydroxide and a lithium compound is fired at 700° C. to 1100° C. to obtain a precursor of the cathode active material;
performing spray drying in which a second mixture of the precursor of the cathode active material and Ni(NO₃)₂ is spray-dried using a spray dryer to obtain a dried product; and
performing second firing in which the dried product is fired at 100° C. to 130° C. to obtain the cathode active material,
wherein, during the spray drying, the inlet air temperature of the spray dryer is 120° C. to 140° C.

The present disclosure can provide a cathode active material that can reduce the internal resistance of a battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing an example of the structure of the cathode active material according to the present disclosure; and

FIG. 2 is a graph showing a spectrum obtained by TEM-EDX of the cathode active material of Example 1.

### DETAILED DESCRIPTION OF EMBODIMENTS

### 1. Cathode Active Material

The present disclosure provides a cathode active material including:
a surface layer that is a region extending from the surface toward the center of the cathode active material to a predetermined depth T; and a core layer that is a region extending from the predetermined depth T to the center.

The surface layer contains at least Ni and does not contain Mn.

The core layer has, in TEM-EDX analysis, a first peak derived from Mn in the range of 640 eV to 650 eV and contains Mn corresponding to the first peak.

The predetermined depth T is 0.9 nm or more and 10 nm or less.

In the present disclosure, the first peak does not appear at the surface in the TEM-EDX analysis of the cathode active material, and Mn that exhibits poorer electronic conducting properties than Ni is not present in the surface of the cathode active material and is present in regions beneath the surface. As a result, an increase in the internal resistance of the battery can be suppressed.

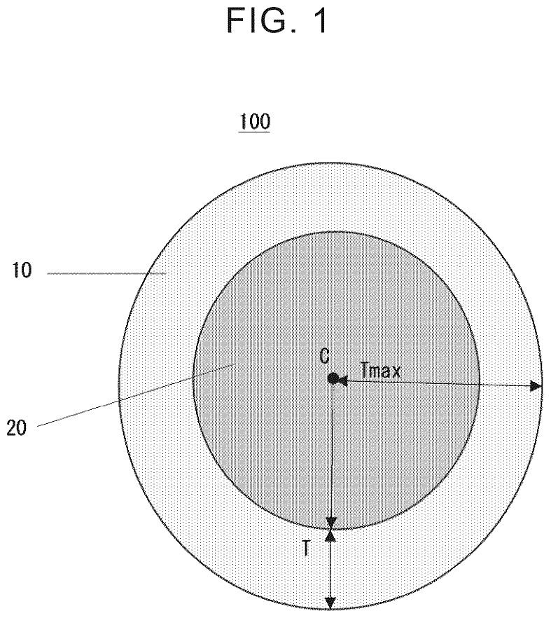

FIG. 1 is a schematic diagram showing an example of the structure of the cathode active material according to the present disclosure. As shown in FIG. 1, a cathode active material 100 of the present disclosure includes a surface layer 10 that is a region extending from the surface toward the center C of the cathode active material 100 to a predetermined depth T; and a core layer 20 that is a region extending from the predetermined depth T to the center C. Tmax shown in FIG. 1 represents the depth from the surface to the center C of the cathode active material 100.

The cathode active material is for use in a battery. The battery will be described in detail later.

The cathode active material may be in the form of particles.

The average particle size of the particles of the cathode active material may be, for example, 0.5 μm or more, 1 μm or more, or 2 μm or more. The average particle size of the particles of the cathode active material may be, for example, 30 μm or less, 10 μm or less, 5 μm or less, or 3 μm or less.

An example of a method for calculating the average particle size in the present disclosure is as follows. First, in a transmission electron microscope (TEM) image or a scanning electron microscope (SEM) image taken at an appropriate magnification (for example, 50,000× to 1,000,000×), the particle size of a given particle is calculated by treating the particle as a sphere. Such particle size calculations based on TEM or SEM observation are carried out for 200 to 300 particles of the same type, and the average of these particle sizes is taken as the average particle size.

The cathode active material has a two-layer structure formed of a surface layer and a core layer.

The cathode active material may include a core layer that contains Mn corresponding to a first peak, and a surface layer (coating layer) that contains at least Ni and covers the surface of the core layer.

The surface layer is a region of the cathode active material extending from the surface toward the center to a predetermined depth T.

The predetermined depth T from the surface of the cathode active material may be a depth of 0.9 nm or more and 10 nm or less from the surface toward the center, may be a depth of 1.0 nm or more and 3.0 nm or less from the surface toward the center, may be 1.0 nm or more and 2.0 nm or less from the surface toward the center, or may be a depth of 1.0 nm from the surface toward the center.

The surface layer contains at least Ni and does not contain Mn.

The surface layer may contain at least Ni and may further contain Co.

In TEM-EDX analysis, the surface layer may have a second peak derived from Ni, and may further have a third peak derived from Co. The second peak may be a peak observed in the range of 850 eV to 860 eV in TEM-EDX analysis. The third peak may be a peak observed in the range of 775 eV to 785 eV in TEM-EDX analysis.

The outermost surface of the surface layer may be the location at which the second peak is first observed when line analysis is performed by TEM-EDX from the surface toward the center of the cathode active material, or may be the outermost location at which Ni is observed when elemental mapping of a cross section of the cathode active material is performed by TEM-EDX.

The surface layer may be a layer that contains either or both of LiNiO₂ and Ni(NO₃)₂, may be a layer made of LiNiO₂, or may be a layer made of Ni(NO₃)₂.

The presence of the surface layer can be confirmed, for example, by performing compositional (elemental) analysis through energy dispersive X-ray spectroscopy (EDX) on a TEM image of the cathode active material. Known methods may be used for the compositional analysis. For example, methods such as scanning electron microscopy-energy dispersive X-ray spectroscopy (SEM-EDX) and X-ray photoelectron spectroscopy (XPS) may be used in addition to TEM-EDX.

The thickness of the surface layer is not particularly limited, but may be, for example, 0.9 nm or more and 10 nm or less, or may be 1.0 nm. The thickness of the surface layer is determined as the average of thicknesses measured at five or more positions in TEM observation of the cathode active material.

The core layer is a region of the cathode active material extending from the predetermined depth T toward the center. In the case where the point at the predetermined depth T of the cathode active material corresponds to the surface layer, the core layer does not include the point at the predetermined depth T.

The outermost surface of the core layer may be the location at which the first peak is first observed when line analysis is performed by TEM-EDX from the surface toward the center of the cathode active material.

The core layer has a first peak derived from Mn in the range of 640 eV to 650 eV in TEM-EDX analysis, and contains Mn corresponding to the first peak.

Whether the first peak is present can be determined as follows. A peak observed in the range of 610 eV to 630 eV in TEM-EDX analysis is taken as a reference peak. When the intensity of the first peak is greater than the intensity of the reference peak, the first peak is regarded as being present.

The first peak is a peak derived from Mn, and may be a peak corresponding to the Mn 2p_{3/2} peak in lithium nickel cobalt manganese oxide. In lithium nickel cobalt manganese oxide, Mn mainly exists in a form corresponding to the crystal structure of LiMnO₂, but partially in other forms such as Li₂MnO₃, MnO₂, Mn₂O₃, or MnO.

The core layer may contain Mn corresponding to the first peak, and may further contain Li, Ni, and Co.

The cathode active material may contain, for example, Li, a transition metal (TM), and O. The cathode active material may be a lithium transition metal composite oxide containing Li, a transition metal, and O.

The lithium transition metal composite oxide used as the cathode active material may contain two transition metals, three transition metals, or four or more transition metals. Examples of transition metals include Ti, V, Cr, Mn, Fe, Co, Ni, Zr, and Nb.

In addition to Li and the transition metals, the lithium transition metal composite oxide may further contain another metal M¹ (including a metalloid) other than Li and the transition metals. Examples of the metal M¹ include Al, Si, Ga, Ge, In, and Sn.

The lithium transition metal composite oxide in the surface layer contains at least Ni as a transition metal and does not contain Mn.

The lithium transition metal composite oxide in the core layer may contain Mn as a transition metal, and may further contain, for example, Ni and Co as transition metals. The lithium transition metal composite oxide in the core layer may contain Li, Ni, Co, Mn, and O.

The total amount of Ni, Co, and Mn contained in the lithium transition metal composite oxide in the core layer, per 1 mol of all metals contained in the lithium transition metal composite oxide excluding Li, is, for example, 0.80 mol or more, 0.90 mol or more, or 0.95 mol or more, or may be 1 mol. The term “total amount of Ni, Co, and Mn” also includes cases where the proportion of one or two of Ni, Co, and Mn is zero.

The lithium transition metal composite oxide in the core layer may have a composition represented by the general formula LiₓNiₐCo_{b}Mn_{c}O_{y} (where 0.1≤x≤1.5, 0.5≤a<1.0, 0≤b≤0.3, 0<c≤0.3, a+b+c=1.0, and 1.5≤y≤2.1).

In the general formula, the Li composition ratio x may be any value that satisfies 0.1≤x<1.5. The Li composition ratio x may be, for example, 0.4 or more, 0.6 or more, 0.8 or more, 1.0 or more, or 1.1 or more. The Li composition ratio x may be 1.4 or less, or 1.2 or less.

In the above general formula, the O composition ratio y may be any value that satisfies 1.5≤y≤2.1. The O composition ratio y may be, for example, 1.6 or more, 1.7 or more, 1.8 or more, or 1.9 or more. The O composition ratio y may be, for example, 2.0 or less.

In the above general formula, the Ni composition ratio a, the Co composition ratio b, and the Mn composition ratio c satisfy a+b+c=1.0.

In the above general formula, the Ni composition ratio a may be any value that satisfies 0.5≤a<1.0. The Ni composition ratio a may be, for example, 0.6 or more, 0.7 or more, 0.8 or more, or 0.85 or more. The Ni composition ratio a may be, for example, 0.9 or less.

In the above general formula, the Co composition ratio b may be any value that satisfies 0≤b≤0.3. The Co composition ratio b may be, for example, 0.01 or more, 0.02 or more, 0.03 or more, 0.04 or more, 0.05 or more, 0.06 or more, 0.07 or more, or 0.075 or more. The Co composition ratio b may be, for example, 0.25 or less, 0.20 or less, 0.15 or less, 0.10 or less, 0.09 or less, or 0.08 or less.

In the above general formula, the Mn composition ratio c may be any value that satisfies 0<c<0.3. The Mn composition ratio c may be, for example, 0.01 or more, 0.02 or more, 0.03 or more, 0.04 or more, 0.05 or more, 0.06 or more, 0.07 or more, or 0.075 or more. The Mn composition ratio c may be, for example, 0.25 or less, 0.20 or less, 0.15 or less, 0.10 or less, 0.09 or less, or 0.08 or less.

The lithium transition metal composite oxide in the core layer may contain any dopant. The dopant herein refers to an element other than Li, Ni, Co, Mn, and O. The dopant may include, for example, at least one selected from the group consisting of Zr, Mo, Mg, Ca, Na, Fe, Cr, Zn, Si, Sn, Al, and Ag. The composition ratio d of the dopant, relative to a+b+c=1.0, may be 0.005 or more, 0.01 or more, 0.02 or more, 0.03 or more, or 0.04 or more. The composition ratio d of the dopant, relative to a+b+c=1.0, may be 0.05 or less.

The lithium transition metal composite oxide in the core layer may be crystalline primary particles.

The lithium transition metal composite oxide in the core layer may be a single-crystal active material formed of the above primary particles. The term “single-crystal active material” refers to an active material that is not a polycrystalline active material (i.e., an active material in which numerous primary particles are densely aggregated). That is, the single-crystal active material may be a single-crystal particle. Single-crystal active materials exhibit less degradation over time than polycrystalline active materials.

In SEM images, a single-crystal active material appears as a single independent particle (primary particle) without apparent agglomeration or aggregation. In SEM images, a single-crystal active material does not exhibit apparent grain boundaries. The magnification for the SEM images may be, for example, from 10,000× to 30,000×.

The lithium transition metal composite oxide may have a layered rock-salt structure. The lithium transition metal composite oxide may also have a crystal structure belonging to space group R-3m.

The particle size of the primary particles of the lithium transition metal composite oxide may be 0.5 μm or more, 0.6 μm or more, 0.8 μm or more, or 1.0 μm or more. If the particle size is too small, the particles may not have grown sufficiently, making it difficult to produce them as single crystals. The particle size of the primary particles may be, for example, 10 μm or less, 5 μm or less, or 3 μm or less. The particle size of the primary particles may be determined, for example, as the maximum diameter in TEM or SEM images. Alternatively, for example, when the cathode layer contains primary particles (lithium transition metal composite oxide), the particle size of the primary particles may be determined from the maximum diameter of the primary particles in a cross-sectional SEM image of the cathode layer. The term “particle size of the primary particles” as used herein does not refer to an average particle size. That is, when multiple primary particles are contained in the cathode layer, the “particle size of the primary particles” refers to the particle size of each individual primary particle.

### 2. Method for Producing Cathode Active Material

The present disclosure provides a method for producing the above cathode active material. The method includes:

performing first firing in which a first mixture of a transition metal hydroxide and a lithium compound is fired at 700° C. to 1100° C. to obtain a precursor of the cathode active material;

performing spray drying in which a second mixture of the precursor of the cathode active material and Ni(NO₃)₂ is spray-dried using a spray dryer to obtain a dried product; and

performing second firing in which the dried product is fired at 100° C. to 130° C. to obtain the cathode active material.

During the spray drying, the inlet air temperature of the spray dryer is 120° C. to 140° C.

In the present disclosure, a lithium transition metal composite oxide is first synthesized. A nitrate is then dissolved in an aqueous solvent, and the lithium transition metal composite oxide dispersed in the aqueous solvent is spray-dried. Subsequently, firing is performed to form a coating layer containing LiNiO₂ on the surface of the lithium transition metal composite oxide. This suppresses an increase in resistance caused by Mn. The cathode active material obtained by the production method of the present disclosure typically includes a core layer formed of a lithium transition metal composite oxide having a composition represented by the general formula LiₓNiₐCo_{b}MnₓO_{y} (0.1≤x≤1.5, 0.5≤a<1.0, 0≤b≤0.3, 0<c≤0.3, a+b+c=1.0, 1.5≤y≤2.1), and a surface layer containing LiNiO₂ on the surface of the core layer.

The method for producing the cathode active material according to the present disclosure includes: (1) a first firing step, (2) a spray drying step, and (3) a second firing step.

### (1) First Firing Step

The first firing step is a step of firing a first mixture of a transition metal hydroxide and a lithium compound at 700° C. to 1100° C. to obtain a precursor of the cathode active material.

The method for producing the transition metal hydroxide used in the present disclosure is not particularly limited, and examples include the following. First, a raw material aqueous solution for the transition metal hydroxide is prepared. As an example of a method for preparing the raw material aqueous solution, a water-soluble transition metal compound may be dissolved in water. Examples of transition metal compounds include metal salts such as sulfates and nitrates. Examples of Ni sources include NiSO₄ and Ni(NO₃)₂. Examples of Co sources include CoSO₄, Co(NO₃)₂, and Co(NO₃)₃. Examples of Mn sources include MnSO₄ and Mn(NO₃)₂. The composition of the raw material aqueous solution is adjusted as appropriate in accordance with the target cathode active material.

Next, a predetermined amount of aqueous NH₃ solution is placed in a reaction vessel, and while stirring the solution with a stirrer etc., the atmosphere inside the reaction vessel is purged with nitrogen to create a non-oxidizing atmosphere. The flow rate of nitrogen gas for the nitrogen purging is not particularly limited, and may be, for example, 2 L/min to 6 L/min. Subsequently, an aqueous sodium hydroxide solution is added to the reaction vessel, and while maintaining the pH in the alkaline range (e.g., pH 11.3 to pH 12.0), the raw material aqueous solution and the aqueous NH₃ solution are added dropwise into the reaction vessel over five hours to 15 hours. The reaction temperature is not particularly limited, and may be, for example, 50° C. or more and 65° C. or less.

After completion of the reaction, preliminary firing may be performed. The preliminary firing can be performed, for example, at 120° C. to 220° C., for four hours to 10 hours at 0.2 Mpa to 1.0 MPa.

After completion of the reaction or after completion of the preliminary firing, the resulting product is washed with water, and filtered to recover the transition metal hydroxide, and the recovered transition metal hydroxide is dried. The drying may be performed, for example, at 110° C. for 10 hours to 12 hours.

In the present disclosure, the transition metal hydroxide contains a transition metal. The transition metal hydroxide may be a nickel-cobalt-manganese composite hydroxide containing nickel (Ni), cobalt (Co), and manganese (Mn). In the nickel-cobalt-manganese composite hydroxide, the proportion (molar ratio) of each metal species to the total amount of nickel, cobalt, and manganese is the same as the composition ratio represented by the above general formula for the lithium transition metal composite oxide in the cathode active material.

The lithium compound (Li source) may be, for example, at least one selected from lithium carbonate, lithium nitrate, lithium acetate, lithium hydroxide, lithium oxide, and lithium chloride. The lithium compound may be lithium hydroxide. The molar ratio of Li in the Li source to the transition metal (TM) contained in the transition metal hydroxide may be, for example, 0.4 or more, 0.6 or more, 0.8 or more, 1.0 or more, or 1.1 or more, and may be 1.4 or less, or 1.2 or less.

The ratio of the lithium compound to the transition metal hydroxide in the first mixture is typically adjusted such that the proportion (molar ratio) of lithium and the other metal species to the total amount of lithium and the metal species contained in the transition metal hydroxide in the target cathode active material typically becomes equal to the proportion (molar ratio) of lithium and the other metal species in the first mixture. The mixing method is not particularly limited, and any known method may be used.

The first mixture may contain a molten salt. Since the molten salt functions as a flux, the primary particles can be sufficiently grown. The molten salt may contain Li. An example of the molten salt is lithium hydroxide. The molar ratio of Li contained in the molten salt to the transition metal (TM) in the transition metal hydroxide (Li/TM) may be, for example, 0.01 or more, or may be 0.05 or more, 0.10 or more, or 0.15 or more. The ratio Li/TM may be, for example, 0.60 or less, or may be 0.50 or less, 0.40 or less, or 0.30 or less.

The first mixture may contain lithium hydroxide as both the Li source and the molten salt. The molar ratio of Li contained in the Li source and molten salt to the TM in the transition metal hydroxide (Li′/TM) may be, for example, 1.01 or more, or may be 1.05 or more, 1.10 or more, or 1.15 or more. The ratio Li′/TM may be, for example, 1.60 or less, or may be 1.50 or less, 1.40 or less, or 1.30 or less.

The first mixture may be fired, for example, at 700° C. to 1100° C. for eight hours to 15 hours to obtain a lithium transition metal composite oxide. A known firing furnace such as a muffle furnace may be used for the firing.

The lower limit of the firing temperature in the first firing step may be 800° C. or more, 850° C. or more, 900° C. or more, or 950° C. or more, and the upper limit thereof may be 1000° C. or less.

The firing time in the first firing step may be nine hours or more, or 10 hours or more. The firing time in the first firing step may be 13 hours or less, or 11 hours or less.

The precursor of the cathode active material obtained by firing the transition metal hydroxide in the present disclosure is typically a single-crystal active material formed of primary particles.

### (2) Spray Drying Step

The spray drying step is a step of spray-drying a second mixture of the precursor of the cathode active material and Ni(NO₃)₂ using a spray dryer to obtain a dried product.

The inlet air temperature of the spray dryer is 120° C. to 140° C. By setting the inlet air temperature to a value that does not exceed the boiling point of Ni(NO₃)₂, the surface of the lithium transition metal composite oxide can be coated with Ni(NO₃)₂.

The intake pressure of the spray dryer may be 1.0 Mpa to 3.0 MPa, or may be 2.0 MPa, and the nozzle pressure of the spray nozzle may be 0.1 Mpa to 0.3 MPa, or may be 0.2 MPa. The mass fraction of Ni(NO₃)₂ in the second mixture is not particularly limited, and may be 1 mass % to 3 mass %, and may be 1.6 mass %.

The second mixture contains at least the precursor of the cathode active material and Ni(NO₃)₂, and may be a slurry obtained by adding the precursor of the cathode active material and Ni(NO₃)₂ to a solvent and stirring the resulting mixture.

Examples of the solvent used in the spray drying step include water and deionized water.

### (3) Second Firing Step

The second firing step is a step of firing the dried product at 100° C. to 130° C. to obtain the cathode active material.

Firing the dried product at 100° C. to 130° C. in the second firing step suppresses vaporization of Ni(NO₃)₂ and makes it possible to obtain a cathode active material having a surface layer containing Ni.

The firing time in the second firing step may be one hour or more, nine hours or more, or 10 hours or more. The firing time in the second firing step may be 15 hours or less, 13 hours or less, or 11 hours or less.

### 3. Battery

The cathode active material provided by the present disclosure can be used as, for example, a cathode active material constituting the cathode layer of a battery (such as a lithium-ion battery). That is, in the present disclosure, a battery is provided in which a cathode layer, an electrolyte layer, and an anode layer are stacked in this order, and the cathode layer contains the cathode active material of the present disclosure.

According to the present disclosure, the internal resistance of a battery can be reduced by using the above-described cathode active material.

The type of battery in the present disclosure is not particularly limited, but is typically a lithium-ion battery. The battery in the present disclosure may be a liquid-electrolyte battery in which the electrolyte layer contains a liquid electrolyte, or a solid-state battery in which the electrolyte layer contains a solid electrolyte. The solid-state battery may be a semi-solid-state battery or an all-solid-state battery. In the present disclosure, a semi-solid-state battery is a battery in which the electrolyte layer contains solid components such as an inorganic solid electrolyte and liquid components (such as a solvent and a liquid electrolyte). In the present disclosure, an all-solid-state battery is a battery in which the electrolyte layer contains solid components such as an inorganic solid electrolyte as the electrolyte. The battery in the present disclosure may be a primary battery or a secondary battery, and may particularly be a secondary battery. This is because a secondary battery can be repeatedly charged and discharged and is useful, for example, as an in-vehicle battery. The shape of the battery is not particularly limited. For example, the battery may be a coin battery, a cylindrical battery, a prismatic battery, a sheet battery, a button battery, a flat battery, or a laminated battery.

In the case of a battery stack in which multiple cells are stacked, the battery stack may be monopolar or bipolar.

Examples of applications of the battery include power sources for vehicles such as hybrid electric vehicles (HEVs), plug-in hybrid electric vehicles (PHEVs), battery electric vehicles (BEVs), gasoline vehicles, and diesel vehicles. In particular, the battery may be used as a drive power source for hybrid electric vehicles (HEVs), plug-in hybrid electric vehicles (PHEV), or battery electric vehicles (BEVs). The battery may also be used as a power source for mobile bodies other than vehicles (for example, trains, ships, and aircraft), or as a power source for electric devices such as information processing devices.

### Example 1

### Synthesis of Transition Metal Hydroxides

NiSO₄, CoSO₄, and MnSO₄ were dissolved in deionized water to prepare a raw material aqueous solution. The molar ratio of Ni, Co, and Mn in the raw material aqueous solution was Ni:Co:Mn=80:10:10. The concentration of the raw material aqueous solution (the proportion of all raw materials in the raw material aqueous solution) was 30 mass %

### Hydrothermal Synthesis (Crystallization)

A predetermined amount of aqueous NH₃ solution was placed in a reaction vessel, and while stirring the solution with a stirrer, the atmosphere inside the reaction vessel was purged with nitrogen. An aqueous NaOH solution was then added to the reaction vessel, and while maintaining the pH at an alkaline level (pH=12) and keeping the temperature constant, the raw material aqueous solution and the aqueous NH₃ solution were added dropwise to precipitate a transition metal hydroxide. The reaction temperature was 60° C., and the reaction time was 10 hours.

### Filtration

After completion of the hydrothermal synthesis, the transition metal hydroxide was dispersed and washed with deionized water. The washed transition metal hydroxide was then filtered to recover the transition metal hydroxide.

### Drying

The transition metal hydroxide was dried at 120° C. for 16 hours to remove moisture.

### Synthesis of Cathode Active Material

### Mixing of Li Raw Material

The dried transition metal hydroxide and LiOH, used as the lithium compound serving as the Li source, were mixed in an agate mortar to obtain a mixture.

The transition metal hydroxide and LiOH were mixed such that the molar ratio of lithium to the total amount of Ni, Co, and Mn (NCM) contained in the transition metal hydroxide (Li/NCM ratio) became 1.1.

### First Firing

The resulting mixture was fired in a firing furnace at 1000° C. for 10 hours under an oxygen atmosphere to synthesize a cathode active material (Li_{1.1}Ni_{0.8}Co_{0.1}Mn_{0.1}O₂), thereby obtaining a first-fired product.

### First Pulverization

The first-fired product was pulverized with a jet mill as a pulverizer and further comminuted to a predetermined particle size.

### Spray Drying

A slurry was prepared by placing 100 mL of deionized water and 0.5 g of Ni(NO₃)₂ in a beaker, and adding 30 g of the first-fired product while stirring. The resulting slurry was spray-dried using a spray dryer to obtain a dried product. The inlet air temperature of the spray dryer was 140° C., the intake pressure was 2.0 MPa, and the nozzle pressure of the spray nozzle was 0.2 MPa.

### Second Firing

The dried product thus obtained was fired in a firing furnace at 100° C. for 10 hours under an oxygen atmosphere to obtain a second-fired product of the cathode active material.

### Second Pulverization

The second-fired product was pulverized with a jet mill as a pulverizer and further comminuted to a predetermined particle size, thereby obtaining particles of the cathode active material.

### Example 2

Except that the inlet air temperature of the spray dryer in “Spray Drying” described above was set to 120° C., the cathode active material was produced in the same manner as in Example 1.

### Comparative Example 1

Except that “Spray Drying,” “Second Firing,” and “Second Pulverization” in “Synthesis of Cathode Active Material” described above were not performed and the particles of the first-fired product obtained in “First Pulverization” of “Synthesis of Cathode Active Material” were used as the cathode active material, the cathode active material was produced in the same manner as in Example 1.

### Comparative Example 2

Except that the inlet air temperature of the spray dryer in “Spray Drying” was set to 200° C., the cathode active material was produced in the same manner as in Example 1.

### TEM-EDX Analysis

Line analysis using TEM-EDX was performed on the cathode active materials of Examples 1 and 2 and Comparative Examples 1 and 2, and the following results were obtained.

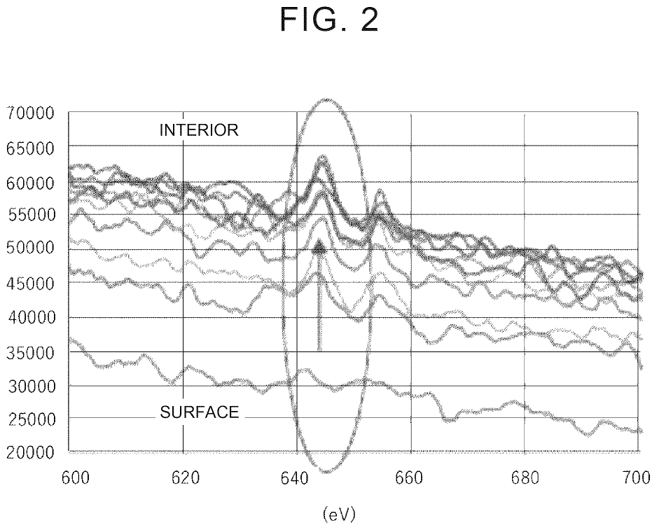

FIG. 2 shows a spectrum obtained by TEM-EDX for the cathode active material of Example 1. The arrow in FIG. 2 indicates the position of the first peak. The lowest profile in FIG. 2 represents the result at the surface (0-nm position), and the depth from the surface increases by 2.0 nm with each profile upward.

For the cathode active materials of Examples 1 and 2, no first peak in the range of 640 eV to 650 eV was observed by TEM-EDX in the region extending from the surface toward the center of the cathode active material particles to a depth of 1.0 nm, whereas the first peak was observed in the region extending from a depth of 1.0 nm toward the center of the cathode active material particles.

Although not shown in the drawings, for the cathode active materials of Examples 1 and 2, the presence of Ni was confirmed by TEM-EDX in both the region extending from the surface toward the center of the cathode active material particles to a depth of 1.0 nm and the region extending from a depth of 1.0 nm toward the center.

Accordingly, it was confirmed that the cathode active materials of Examples 1 and 2 have a surface layer that contains Ni but does not contain Mn, and a core layer that contains Mn corresponding to the first peak.

For the cathode active materials of Comparative Examples 1 and 2, the first peak in the range of 640 eV to 650 eV was observed by TEM-EDX throughout the entire region of the cathode active material particles.

In Comparative Example 2, since the inlet air temperature of the spray dryer in “Spray Drying” was set higher than the boiling point of Ni(NO₃)₂ (135° C.), it is presumed that Ni(NO₃)₂ vaporized and, as a result, a coating layer containing Ni was not formed.

### Cell Fabrication (Wound Cylindrical Cells)

Wound cylindrical cells of Examples 1 and 2 and Comparative Examples 1 and 2 were fabricated using the cathode active materials of Examples 1 and 2 and Comparative Examples 1 and 2, respectively.

Specifically, a cathode mixture paste containing the cathode active material, acetylene black as a conductive additive, and polyvinylidene fluoride as a binder was applied onto the surface of a metal foil serving as a cathode current collector using a film applicator with a thickness adjustment function (manufactured by Allgood Co., Ltd.). The coated metal foil was then dried at 80° C. for five minutes in a dryer to prepare a cathode having a cathode layer on the cathode current collector. The cathode mixture paste had a mass ratio of 88:10:2 (cathode active material:conductive additive:binder).

An anode mixture paste containing natural graphite as an anode active material, styrene-butadiene rubber (SBR) as a binder, and carboxymethyl cellulose (CMC) as a thickener was applied onto the surface of a metal foil serving as an anode current collector using a film applicator with a thickness adjustment function (manufactured by Allgood Co., Ltd.). The coated metal foil was then dried at 80° C. for five minutes in a dryer to produce an anode having an anode layer on the anode current collector.

A 1 M LiPF₆ solution containing LiPF₆ as an electrolyte and ethylene carbonate (EC), dimethyl carbonate (DMC), and ethyl methyl carbonate (EMC) as a solvent in a volume ratio of EC/DMC/EMC=3/4/3 was prepared as an electrolyte solution.

The cathode, a separator, and the anode were stacked, and the separator was impregnated with the electrolyte solution. Wound cylindrical cells of Examples 1 and 2 and Comparative Examples 1 and 2 were fabricated.

### Cell Evaluation

I-V resistance was measured for each of the fabricated wound cylindrical cells.

### Measurement of I-V Resistance

In the voltage range of 3.0 V to 4.3 V, the upper limit voltage of 4.3 V was defined as SOC 100%, and the voltage was adjusted such that the SOC became 50%. Discharge was performed at 25° C. for 10 seconds at 0.1 C, 0.3 C, 0.5 C, 0.7 C, and 1.0 C, and the voltage drop (V) observed during the discharge was measured.

The relationship between current and voltage drop (V) was plotted, and the slope of the straight line obtained by linear approximation was defined as the I-V resistance. The results are shown in Table 1. The resistance values of Examples 1 and 2 and Comparative Examples 1 and 2 shown in Table 1 are relative values, with the resistance value of Comparative Example 1 defined as 100%.

TABLE 1

| | | | | | | | Resistance at |
|---|---|---|---|---|---|---|---|
| | | | | | Spray | Surface Layer | 25° C. |
| | Cathode Active Material | | | | Drying | (T = 1.0 nm) | Relative Value % |
| | Li/NCM | Ni/NCM | Co/NCM | Mn/NCM | Temperature | Presence/Absence | (Comparative |
| | Ratio | Ratio | Ratio | Ratio | ° C. | of First (Mn) Peak | Example 1 = 100%) |
| Comparative Example 1 | 1.1 | 0.8 | 0.1 | 0.1 | — | Present | 100 |
| Comparative Example 2 | 1.1 | 0.8 | 0.1 | 0.1 | 200 | Present | 101 |
| Example 1 | 1.1 | 0.8 | 0.1 | 0.1 | 140 | Absent | 92 |
| Example 2 | 1.1 | 0.8 | 0.1 | 0.1 | 100 | Absent | 89 |

As shown in Table 1, the batteries using the cathode active materials of Examples 1 and 2 exhibit lower internal resistance than the batteries using the cathode active materials of Comparative Examples 1 and 2. This demonstrates that the absence of Mn in the surface layer of the cathode active material enables a reduction in the internal resistance of the battery.

What is claimed is:

1. A cathode active material comprising:
a surface layer that is a region extending from a surface toward a center of the cathode active material to a predetermined depth T; and
a core layer that is a region extending from the predetermined depth T to the center, wherein:
the surface layer contains at least Ni and does not contain Mn;
the core layer has, in TEM-EDX analysis, a first peak derived from Mn in a range of 640 eV to 650 eV and contains Mn corresponding to the first peak; and
the predetermined depth Tis 0.9 nm or more and 10 nm or less.

2. The cathode active material according to claim 1, wherein the core layer further contains Li, Ni, and Co.

3. The cathode active material according to claim 1, wherein the predetermined depth Tis 1.0 nm.

4. A battery comprising a cathode layer containing the cathode active material according to claim 1.

5. A method for producing the cathode active material according to claim 1, the method comprising:
performing first firing in which a first mixture of a transition metal hydroxide and a lithium compound is fired at 700° C. to 1100° C. to obtain a precursor of the cathode active material;
performing spray drying in which a second mixture of the precursor of the cathode active material and Ni(NO₃)₂ is spray-dried using a spray dryer to obtain a dried product; and
performing second firing in which the dried product is fired at 100° C. to 130° C. to obtain the cathode active material,
wherein, during the spray drying, an inlet air temperature of the spray dryer is 120° C. to 140° C.
